(19) United States
(12) Patent Application Publication
(10) Pub. No.: US 2009/0171486 A1
(43) Pub. Date: Jul. 2, 2009

(54) PERSONAL MESSAGING DEVICE WITH VISUAL INDICATORS

(76) Inventor: Ronald Gerald Lindsay, JR., Raleigh, NC (US)

Correspondence Address: PASSE' INTELLECTUAL PROPERTY, LLC, 1717 BRASSFIELD RD., RALEIGH, NC, 27614, US

(21) Appl. No.: 11/968,173

(22) Filed: Jan. 1, 2008

(51) Int. Cl. G06F 17/00

(52) U.S. Cl. 700/94

(57) ABSTRACT

The present invention relates to a personal recorder with indicator lights corresponding to each channel with visual indicators to see if there is a message on each channel.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to personal digital messaging recorders. In particular, the present invention relates to a device for recording multiple personal messages on different channels with visual indicators to show if there is a message waiting on each channel.

2. Description of Related Art

The invention of digital recording chips has led to a myriad of devices and uses involving messaging and recording. They have the advantage of being small, easy to use and the devices that allow the chip to record and playback messages relatively small when compared with analog devices.

Digital recording chips have been incorporated into telephone answering machines having multiple mailboxes wherein boxes can be selected by the caller via his telephone and then listened to by the user. These devices, while large and bulky, do provide multiple messaging when hooked up to the phone line and provided with electrical power. They do involve battery backup but are too energy consuming to operate on battery alone. Digital recording devices with playback have been incorporated into other items such as greeting cards, desktop computers, note pads and the like, which can all be used for the purpose of leaving a message for oneself or for other members of the business or household.

Digital voice recording devices have proliferated and a number of companies make devices largely designed to be long play devices. They have multiple channels and usually a number of other features which require use of an LCD or other screen to access and program the device. They are designed for those situations where in-depth recording is necessary for example where transcription later would be useful. The devices are small but expensive and complicated to use.

One of the newer uses of the digital recording chip is use in the personal digital voice recorder. Since these are battery operated devices, they are designed to just record and playback short recordings, thus the devices can be relatively small. The devices differ from the standard digital recorders as well in that they are simpler to use and lack the LCD type screen since there are fewer functions. They are designed as reminders such as where I left my car or for household members to leave messages to other household members. A number of devices are on the market at the point of filing of the present invention. For example, “My Lil Reminder”, is a key chain personal recording device which records about a 20˜60 second message with playback capabilities. “Word Up” personal voice recorder is essentially the same device although it is capable of recording longer than a 20 second message. Another more complicated device is the VXI-Voice it VT300 personal digital voice recorder. This item records up to 5 minutes of messages and stores messages on 4 channels. The channels are accessed by a single channel button which allows you to scroll through the 4 channels. Channels are identified by one of two different audio indicators as well as a single LED light which blinks the number of times corresponding to the channel being used. There is no indicator when there is a message on any channel and the single LED is used only as an indicator of which channel is currently being used. One must scroll through the channels in order to listen to a particular channel.

The personal recorder has uses ideal for remembering names, appointments, messages left by one member of the household for the other, and the like. However, currently there is no personal voice recorder that allows one at a glance to know if there is a message waiting for them on a particular channel and to record directly on a particular channel. Accordingly, it is an objective of the present invention to provide a new invention that overcomes those shortcomings of current personal recording devices.

### BRIEF SUMMARY OF THE INVENTION

The present invention relates to a personal digital voice recorder with a plurality of channels and having a visual LED light indicator for each channel indicating if there is an active message on that channel. The active message light can be used when one person leaves a message for another or just as a reminder that the message on that channel needs some particular activity. The device also allows direct recording on any particular channel and to erase the active message or active indicator from any channel in any order. The present invention thus overcomes the problems and solves the needs and objectives as described above.

In one embodiment the present invention provides a personal reminder digital voice recorder comprising:
a) A battery operated audio microchip system for recording, storing and reproducing a single personal audio recording on each of a plurality of channels;
b) an individual playback button assigned to each of the plurality of channels;
c) an LED corresponding to each of the channels, each LED having a means to turn the LED on when the channel has an active message recorded; and
d) a means to turn each LED off when a corresponding channel has a message that is inactive.

In another embodiment the present invention provides a personal reminder digital voice recorder comprising:
a) A battery operated audio microchip system for recording, storing and reproducing a single personal audio recording on each of a plurality of channels;
b) A single playback button which can operate each of the plurality of channels;
c) an LED corresponding to each of the channels, each LED having a means to turn the LED on when the channel has an active message recorded; and
d) a means to turn each LED off when a corresponding channel has a message that is inactive.

These and other objects of the present invention will be clear when taken in view of the detailed specification and disclosure in conjunction with the appended figures.

### BRIEF DESCRIPTION OF THE DRAWINGS

FIG. 1 is a frontal perspective of an embodiment of the present invention.

FIG. 2 is another embodiment of the present invention.

FIG. 3 is a flow schematic of an embodiment of the present invention.

### DETAILED DESCRIPTION OF THE INVENTION

Prior to the present invention there has been no personal digital recording device available which cheaply and effectively allows recording with an accompanying visual indication for each channel. By assigning an individual LED to each channel and an individual playback button to each channel in a personal recorder, the problems of the prior devices are overcome and the objects as described above met. For example, one person could leave a message on a given channel activating the active light on that channel and another person picking up the device would know instantly that a message was active and on what channel it was left. The message could be listened to in a one button press thus making the device extremely convenient for personal and reminder messages.

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

The terms “a” or “an”, as used herein, are defined as one as or more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “and an embodiment” or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

As used herein the term “personal reminder digital voice recorder” refers to a device with a digital recording media designed for recording relatively short messages as opposed to recording long detailed messages such as on a telephone answering machine. In general, short refers to recording less than about 15 minutes in one embodiment, in another embodiment about 10 minutes or less and in yet another embodiment less than about 5 minutes. In yet another embodiment, it refers to a time of about 3 minutes or less per recording channel. In another embodiment about 2 minutes or less per channel. It also refers to recording devices which can record without complicated means or button pressing as would be the case with long memo type digital recording devices.

As used herein, “battery operated” refers to devices which operate solely on batteries as opposed to electrical devices which comprise a battery backup. By being relatively small and battery operated, the devices are small, lightweight and relatively simple to use. In addition, since they have few or no moving parts, the batteries last a relatively long time unlike batteries in electrical recording devices that may only last minutes of recording time.

The audio microchip system of the present invention is a microchip system capable of recording a digital audio message, storing it and reproducing the audio recording. This can use any type of memory such as flash memory or the like. The device then will have a microphone, one or more speakers, a record button and the like. Since this is a personal recording device, the smaller and lighter the buttons are the more it will be a personal recorder. In one embodiment small click switches are used. The present invention involves a plurality of recording channels and is capable of making a single recording on each channel. In one embodiment, there are between 3 and 7 channels and in another embodiment there are between 5 and 7 channels. The number of messages possible in the present invention, then, corresponds exactly to the number of channels available on each device. In one embodiment there are record buttons corresponding to each channel while in another embodiment there is one record button which can be used with the channel playback buttons to record a message on each channel.

The present invention device will in one embodiment have a single playback button corresponding to each channel of audio recording on the instant device. A 4 channel device will have 4 playback buttons, a 7 channel device 7 playback buttons and the like. Because a separate playback button is available for each channel, one can playback a message recording or the like with a one button press. Each of the buttons can be similar or each can be different to distinguish them from each other. So, for example, the buttons can be different colors, different shapes or the like. The buttons can be located anywhere on the device but in one embodiment they are located on a side of the device while in another embodiment they are located on multiple sides of the device of the present invention device.

As used herein the term “active message” refers to a message recorded on a selected channel which either has not yet been listened to or is in need of activity or which the user wishes to still be reminded to do something with or the like. The present invention has a separate LED light corresponding to each of the channels. The LED's can be the same or different colors but each corresponds to a single channel. The LEDs can be mounted any place as desired on the present device. In one embodiment they are mounted near the playback button for each channel or in one embodiment they are mounted in the playback button for the corresponding channel. The LED in one embodiment is activated by recording a message on a channel corresponding to the LED and then turned off when the message is listened to or played back. In one embodiment the LED is turned off separate from listening to the message for example with a switch that must be engaged to turn off the LED. An inactive message, one not needed to be reminded about, then is indicated by either manually or automatically turning off the corresponding LED. In yet another embodiment of the present invention the LED light corresponding to a single channel can be lit as different colors. Thus, it could light one color indicating a new message and another color indicating a message still recorded on a channel but already listened to. Colors could also indicate who left the message or used to indicate the priority for the message (for example green for low priority and red for high priority). Multiple colors for the LED can be accomplished by actually using an LED product containing multiple LED chips corresponding to different colors of light or using colored filters which are moved in front of a single LED.

Most of the functions can also be programmed to stop automatically to prevent the unit staying on and the need for an on/off switch can be eliminated by the unit being wired to turn on with the press of any button which engages an activity. Another useful function is to supply a separate or incorporated memory that prevents loss of the messages during battery changing. The device can be made relatively flat and light weight since the availability of lightweight buttons and minimal function obviates the need for a large case for the present invention device. Further, the device in one embodiment has an on/off means. This can be an auto on/off function or in another embodiment an on/off switch. In one embodiment there is also a fast forward and or reverse button for a particular channel or for the active channel.

In use one person can record a message say, for example, on channel 3, in this embodiment designated by a red LED. The person picks up the device and presses a record button and then the channel 3 playback button in series or simultaneously initiating recording. In another embodiment a record button corresponding to the channel is pressed to start recording. The corresponding channel LED light is lit. The recording is stopped by for example pressing the record button again or releasing the depressed button or buttons and the user puts it in a place where another person can find it. The other person looks for the device and noticing an LED is lit, knows to pick up the device and press the corresponding play button and listen to a message. In one embodiment listening to the message turns off the corresponding LED but in another embodiment the LED light remains on until the user decides to turn it off. That way the person will remember there is still a message on the device to do something with since the determination to turn of the LED is with the user. The different playback buttons can be assigned to different people, events, ideas and the like and by engaging or disengaging the corresponding LED lights one can keep track simply of short personal messages and know who left the message, when one still needs to listen to something or do something with a particular message without needing to scroll, look at a list or the like with the device as with more complicated devices in the art.

Other embodiments would include some form of recording indicator light. This could be a blinking light with one for each channel or one that indicates simple recording in progress. It could also be the channel light which doubles as the record light. In yet another embodiment of the present invention there is a locking means to prevent accidental recording or playback or the like. The lock could be a slide lock or could be accomplished by multiple presses of buttons or the like. One skilled in the art could add a locking means. One other embodiment of the present invention involves starting to record automatically erases the present message on a channel. In another embodiment the message must be actively erased and recording on a particular channel will add on to the existing message unless the message is first erased. Other combinations of features could also be included as needed in the present invention.

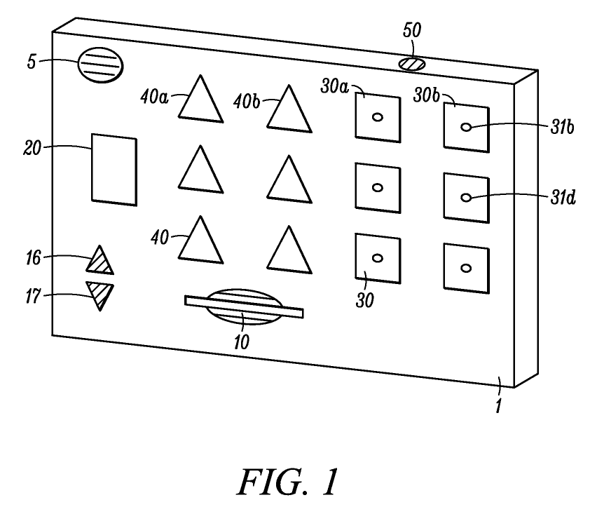

Now referring to the drawings, FIG. 1 is a first embodiment of the personal message device 1 of the present invention. This embodiment shows an ultra thin credit card sized recorder. This particular embodiment has no on or off buttons and is activated when any of the buttons are depressed. Other embodiments could include an on/off switch, a power lock, or the like if necessary to prevent accidently triggering an action on the device. The embodiment of the personal message device 1 depicted in FIG. 1 is a version where there are playback buttons for each channel. In this view, there are 6 playback buttons but any number 2 or more could likewise be depicted and within the scope of the present invention. Playback buttons 30a and 30b are indicated with 4 additional playback buttons below them. Each playback button 30 has a corresponding LED light 31, 31a, 31b, 31c etc built into the playback button 30. This way if there is a message recorded on the personal recording device 1, the channel it is on is instantly recognized and playback can begin merely by pressing the corresponding playback button. So, for example, if LED 31b were lit, one would know to depress playback button 30b to listen to a new or active message.

In this view of FIG. 1, each playback button 30 has a corresponding record button 40. So, for example, depressing button 40a or 40b respectively would engage recording of the corresponding channel or depressing button 30a or 30b would engage playback. This design allows for single button presses for the two major actions of the device: channel playback and channel recording.

Other important personal recorder features are shown. A microphone 5 is conveniently located away from the playback buttons 30 and record buttons 40 for use in recording the message. Playback speaker 10 is located for ease of listening of the playback of each of the messages. In order to adjust the volume during playback volume buttons up volume 16 and down volume 17 are provided. The particular embodiment version plays at the same level as it last played at and can be adjusted in volume using the up 16 and down 17 controls as necessary during playback.

An erase button 20 can be used to erase any one of the channels. In this embodiment only one erase button 20 is provided. In this embodiment channels are erased by pressing the erase button followed by the playback button of the channel desired to be erased. While this is a 2 fingered erase, a single button press erase for each channel could be provided.

The embodiment of the personal recording device 1 in FIG. 1 has LED lights which light upon recording a message and which turn off when the message is listened to. The lights could turn on and be constantly illuminated or blink in a random or particular pattern. For example, a series of 2 blinks for channel two or a series of 3 blinks for channel 3, etc. Other LED lighting scenarios would be involved with other embodiments. So, for example, an LED light could remain lit as long as the corresponding channel has a recording and the LED would be turned off by erasing the message. The device 1 could also be equipped with multiple ways to turn off the LED which can be chosen by the personal recording device 1 user. Another embodiment has the LED lights different colors for each channel.

Another feature of the present invention is an ear phone jack 50. In the event one wants to listen to a personal message, the use of an ear plug could be added to the device 1 to ensure some level of privacy. A standard mini or other ear plug jack would accept the corresponding earphone plug.

The depiction of the present device as a thin credit card is for embodiment illustration only. Other sizes could be made or offered depending on the needs and uses of the particular customer who is purchasing such a device. The device could have its own carrying case, belt carrier, or other standard accessories used with personal recording devices.

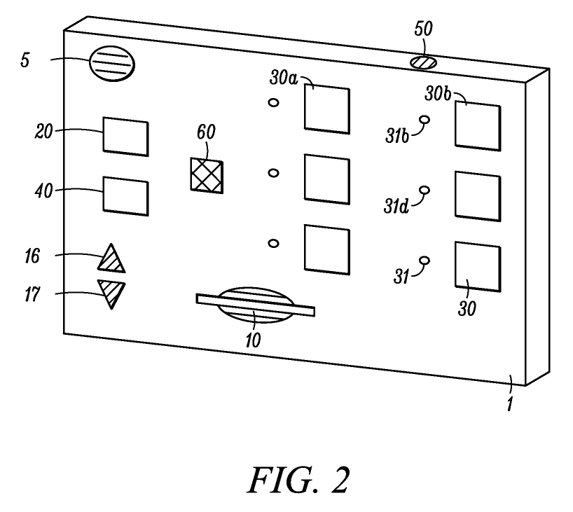

FIG. 2 is another embodiment of the personal recording device 1 of the present invention. In this embodiment, once again for illustration purposes, there are 6 recording channels depicted by the 6 playback buttons 30. Once again as in FIG. 1 the first two are also numbered as 30a and 30b. In this embodiment however the LED 31 is separate from the playback buttons 30. LED 31b is next to playback button 30b and so on. While the LED is not on the playback button, by positioning the LED near each playback button 30 it is easy to determine what LED corresponds to which button.

In this embodiment there is a single erase button 20 and a single record button 40. The record button works like the erase button of FIG. 1 where the record button is held momentarily or first followed by pressing the desired channel playback button to record a message. This version has a separate button to be an LED status button 60. This button can turn an LED light on or off as desired in a manual means for lighting the corresponding LED lights. In another embodiment the LED is a color changing LED where multiple colors correspond to each channel. This embodiment can be used to identify the type of message, for example, green is a message from the wife and blue a message from one of the children. The device likewise has the same remaining components of the personal recording device as in FIG. 1.

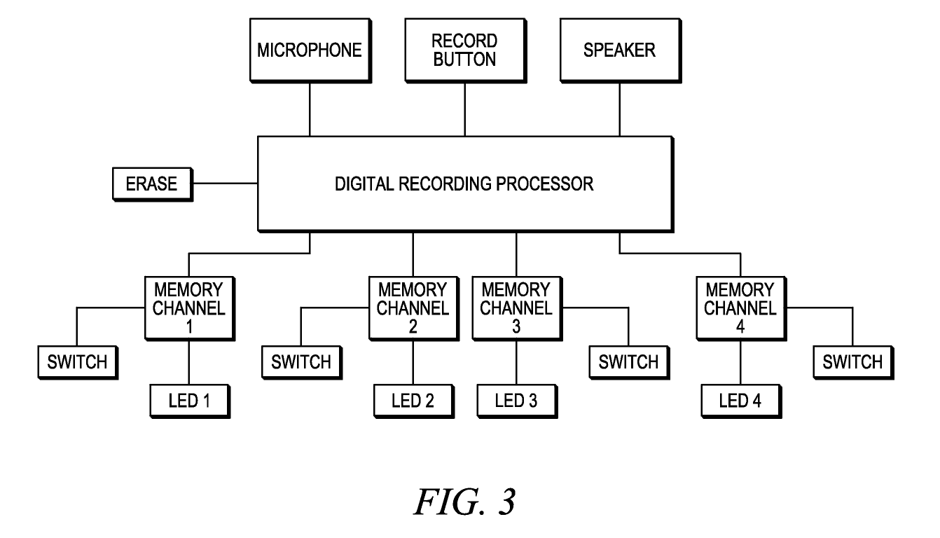

FIG. 3 is a schematic diagram of the workings of one embodiment of the present invention. In this embodiment there are 4 channels to the device. The microphone, record button, speaker, and erase button all are under control of the digital recording processor of the device. In this embodiment the 4 channels each have a switch for playback or for use in combination with other buttons to effect playback or recording. As noted in the schematic, each channel has a corresponding LED. Accordingly, messages and the like can be indicated in the proper channel by lighting the corresponding LED.

The present device can be wired by those skilled in the art by any known means for wiring and using digital recording processors. In the particular embodiments depicted as discussed above, the personal digital recorder can be made a slim credit card model as shown in the drawings or can be in any housing determined proper for the particular personal use. The light indicators and individual playback buttons of the present invention are key components which allow ease of use not previously available with personal digital recorders with one or especially with more than one channel.

Other accessories can be included with the present device so, for example, the device could also comprise a built in clip or pin for attachment to clothes, purses, belts, book bags, and the like. It could include a strap for wearing it on a wrist like a watch, it could include a keychain or belt clip to carry on the person or with keys and it could also have an ear-clip holder accessory to apply the speaker directly to the ear for private listening without the earplug or headphones described above. Other accessories could be included and are contemplated with this scope.

It is clear that various embodiments are possible within the scope of the present invention. Those changes are within the intended scope of the present invention and included in the scope of the claims which follow.

What is claimed is:

1. A personal reminder digital voice recorder comprising:
a) a battery operated audio microchip system for recording, storing and reproducing a single personal audio recording on each of a plurality of channels;
b) an individual playback button assigned to each of the plurality of channels;
c) an LED corresponding to each of the channels, each LED having a means to turn the LED on when the channel has an active message recorded; and
d) a means to turn each LED off when a corresponding channel has a message that is inactive.

2. A digital voice recorder according to claim 1 wherein each LED is on the corresponding playback button.

3. A digital voice recorder according to claim 1 wherein each LED is positioned near the corresponding playback button.

4. A digital voice recorder according to claim 1 wherein there are between 3 and 7 channels.

5. A digital voice recorder according to claim 4 wherein there are from 5 to 7 channels.

6. A digital voice recorder according to claim 1 wherein the total recording time for all channels combined is 15 minutes or less.

7. A digital voice recorder according to claim 1 wherein an LED light automatically comes on any time there is a message on the channel corresponding to the LED.

8. A digital voice recorder according to claim 1 wherein an LED light can be turned off separate from erasing the corresponding message.

9. A digital voice recorder according to claim 1 wherein the LED light corresponding to a channel can be turned on separate from recording a message on the channel.

10. A digital voice recorder according to claim 1 wherein the LED lights corresponding to each channel are a different color.

11. A digital voice recorder according to claim 1 wherein the LED lights corresponding to each channel are the same color.

12. A digital voice recorder according to claim 1 wherein the LED corresponding to each channel is capable of lighting in more than one color.

13. A personal digital recording device comprising a plurality of recording/playback channels wherein there is a playback button operating the playback for each of the channels on the device and there is a light corresponding to each playback button to indicate when the channel has an active message.

14. A personal reminder digital voice recorder comprising:
a) a battery operated audio microchip system for recording, storing and reproducing a single personal audio recording on each of a plurality of channels;
b) a single playback button which can operate each of the plurality of channels;
c) an LED corresponding to each of the channels, each LED having a means to turn the LED on when the channel has an active message recorded; and
d) a means to turn each LED off when a corresponding channel has a message that is inactive.
